(19) United States
(12) Patent Application Publication
(10) Pub. No.: US 2013/0246376 A1
(43) Pub. Date: Sep. 19, 2013

(54) METHODS FOR MANAGING DATA INTAKE AND DEVICES THEREOF

(71) Applicants: Rajan Padmanabhan, Chennai (IN); Asha Uday Patki, Phoenix, AZ (US); Girish Shantharama, Mangalore (IN)

(72) Inventors: Rajan Padmanabhan, Chennai (IN); Asha Uday Patki, Phoenix, AZ (US); Girish Shantharama, Mangalore (IN)

(73) Assignee: INFOSYS LIMITED, Bangalore (IN)

(21) Appl. No.: 13/422,910

(22) Filed: Mar. 16, 2012

(51) Int. Cl. G06F 17/30

(52) U.S. Cl. 707/694; 707/E17.005

(57) ABSTRACT

This technology defines one or more of initial validation rules, one or more source to target mapping instructions, one or more data filtering rules, one or more data validation rules, one or more data transformation rules, and one or more file definition rules. The initial validations are performed on one or more source files based on the initial validation rules. The initially validated source files are mapped into a staging database based on the source to target mapping instructions. The data filtering rules are applied to the mapped source files in the staging database. Validation and transformation are performed on each of the successfully filtered source files based on the data validation rules and the data transformation rules. The validated and transformed source files are loaded into a core database. One or more load ready files are generated from the loaded source files based on the target file generation filtering rules.

### FIELD

This technology relates to methods for managing data intake and devices thereof.

### BACKGROUND

Managing data intake for different vendor computing devices executing different applications which each require a custom file format is very difficult. Additionally, the quality and format of the source data which is received and needs to be mapped from these custom file formats into an enterprise standard is very challenging and time consuming. Further, the applications being executed by each of the vendor computing devices often require different rules and instructions for data validation, data standardization, and other transformations.

Currently, there are no effective automated methods for managing and integrating this incoming data for the applications executing on different vendor computing devices. Additionally, there is no effective way to manage exceptions to accept some types of incoming data, reject other types of incoming data, or report the successes, exceptions, and rejections to the vendor computing devices. Instead, existing mechanisms for managing the intake of data are time consuming, restrictive, expensive and inefficient.

### SUMMARY

A method for managing data intake includes defining by a data intake management computing device one or more of initial validation rules, one or more source to target mapping instructions, one or more data filtering rules one or more data validation rules, one or more data transformation rules, and one or more file definition rules. The one or more initial validations are performed by the data intake management computing device on one or more source files based on the one or more of initial validation rules. The initially validated source files are mapped by the data intake management computing device into a staging database based on the one or more source to target mapping instructions. The one or more data filtering rules are applied by the data intake management computing device to the mapped source files in the staging database. Validation and transformation are performed by the data intake management computing device on each of the successfully filtered source files based on the one or more data validation rules and the one or more data transformation rules. Each of the successfully validated and transformed source files are loaded by the data intake management computing device into a core database. One or more load ready files are generated by the data intake management computing device from the validated, transformed and loaded source files based on the one or more file definition rules. The generated load ready files are provided by the data intake management computing device to a requesting target computing device.

A non-transitory computer readable medium having stored thereon instructions for managing data intake comprising machine executable code which when executed by at least one processor, causes the processor to perform steps including defining one or more of initial validation rules, one or more source to target mapping instructions, one or more data filtering rules one or more data validation rules, one or more data transformation rules, and one or more file definition rules. The one or more initial validations are performed on one or more source files based on the one or more of initial validation rules. The initially validated source files are mapped into a staging database based on the one or more source to target mapping instructions. One or more data filtering rules are applied to the mapped source files in the staging database. Validation and transformation are performed on each of the successfully filtered source files based on the one or more data validation rules and the one or more data transformation rules. Each of the successfully validated and transformed source files are loaded into a core database. One or more load ready files are generated from the validated, transformed and loaded source files based on the one or more file definition rules.

A data intake management computing apparatus includes a memory coupled to one or more processors which are configured to execute programmed instructions stored in the memory including defining one or more of initial validation rules, one or more source to target mapping instructions, one or more data filtering rules one or more data validation rules, one or more data transformation rules, and one or more file definition rules. The one or more initial validations are performed on one or more source files based on the one or more of initial validation rules. The initially validated source files are mapped into a staging database based on the one or more source to target mapping instructions. The one or more data filtering rules are applied to the mapped source files in the staging database. Validation and transformation are performed on each of the successfully filtered source files based on the one or more data validation rules and the one or more data transformation rules. Each of the successfully validated and transformed source files are loaded into a core database. One or more load ready files are generated from the validated, transformed and loaded source files based on the one or more file definition rules.

This technology provides a number of advantages including providing methods, non-transitory computer readable medium and devices that more efficiently and effectively manage the intake of any kind of incoming data. With this technology, received data files can be automatically processed in any custom file format required by applications executing at requesting target computing devices. With this technology, the source data files, target data file specification, data validation, data standardization, data transformation, data publication, exception categorization and reprocess are efficiently stored in a centralized configuration database that can be efficiently reused for other process. Additionally, this technology enables rules and instructions for data validation, data standardization, and other transformations to be resolved at the front end. Further, this technology enables incoming data to be properly processed and mapped to custom target file formats. This technology also provides a standard and automated audit reporting mechanism for the requesting target computing devices.

### BRIEF DESCRIPTION OF THE DRAWINGS

FIG. 1 is an environment with an exemplary data intake management computing device;

FIG. 2 is a function diagram illustrating the environment with the exemplary data intake management computing device illustrated in FIG. 1;

FIG. 3 is a flow chart of an exemplary method for incoming source file management;

FIG. 4 is a flow chart of an exemplary method for data standardization; and

FIG. 5 is a flow chart of an exemplary method for data publication.

### DETAILED DESCRIPTION

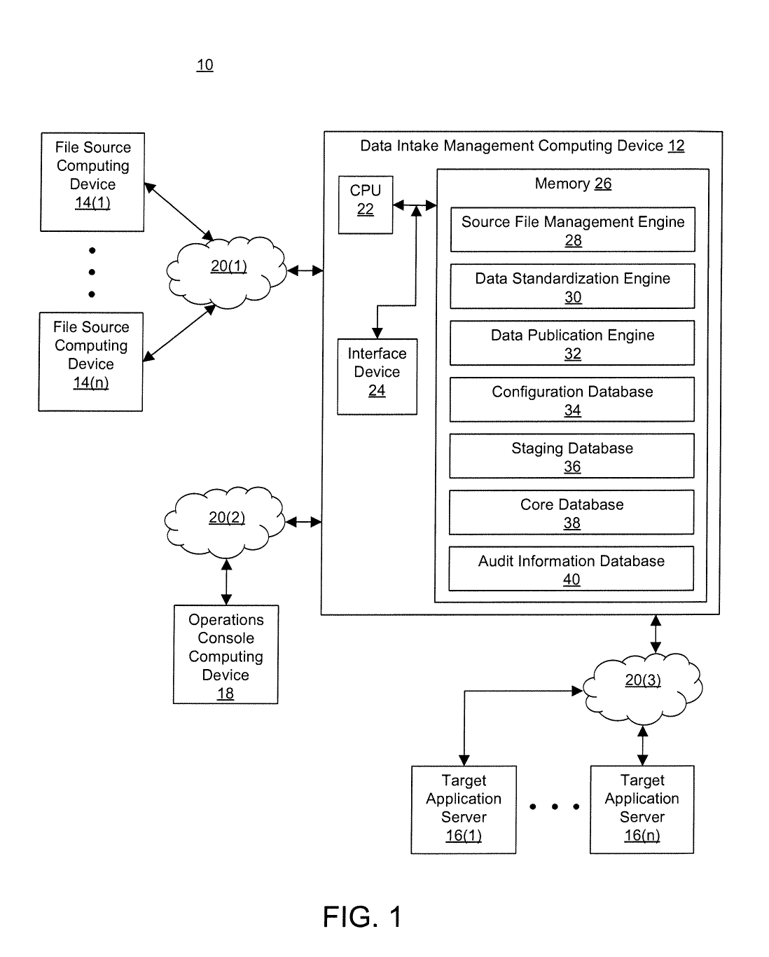

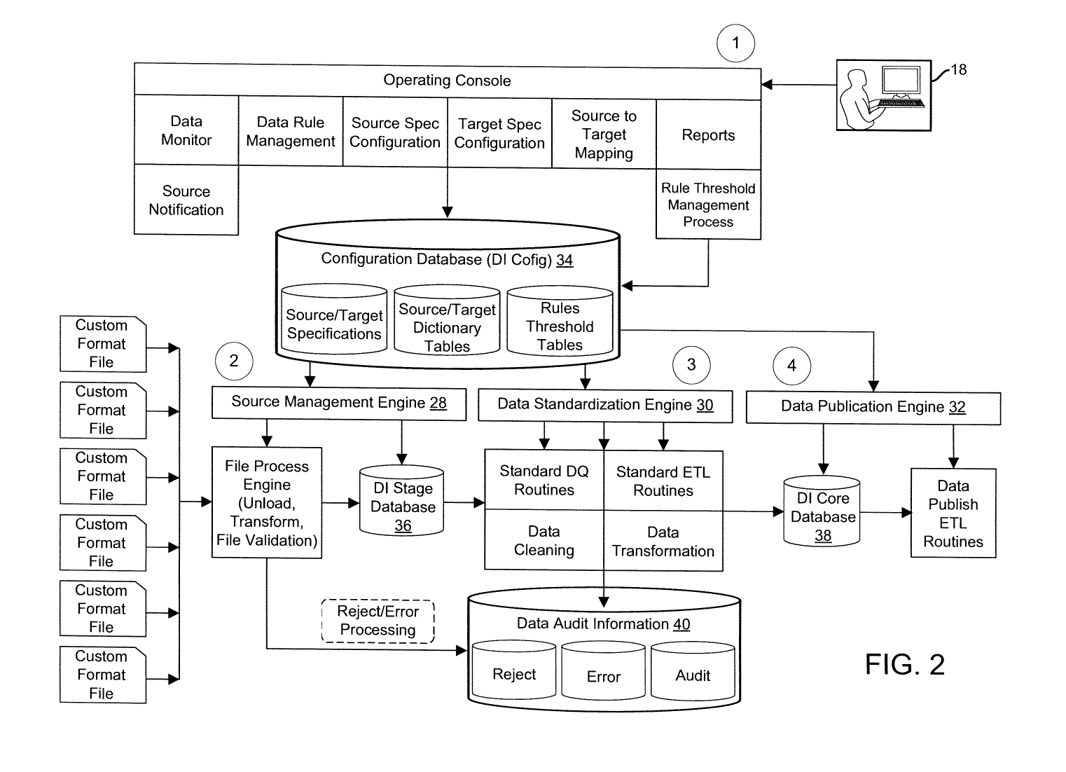

An environment 10 with an exemplary data intake management computing device 12 is illustrated in FIGS. 1-2. The environment 10 includes the data intake management computing device 12, file source computing devices 14(1)-14(n), target application servers 16(1)-16(n), and an operations console computing device 18 which are all coupled together by one or more communication networks 20(1)-20(3), although this environment can include other types and numbers of systems, devices, components, and elements in other configurations, such as multiple numbers of each of these apparatuses and devices. This technology provides a number of advantages including providing methods, non-transitory computer readable medium and devices that more efficiently and effectively manage the intake of any kind of incoming data.

The data intake management computing device 12 includes a central processing unit (CPU) or processor 22, a memory 24, and an interface device 26 which are coupled together by a bus or other link, although other numbers and types of systems, devices, components, and elements in other configurations and locations can be used. The processor 22 executes a program of stored instructions for one or more aspects of the present technology as described and illustrated by way of the examples herein, although other types and numbers of processing devices and logic could be used and the processor could execute other numbers and types of programmed instructions.

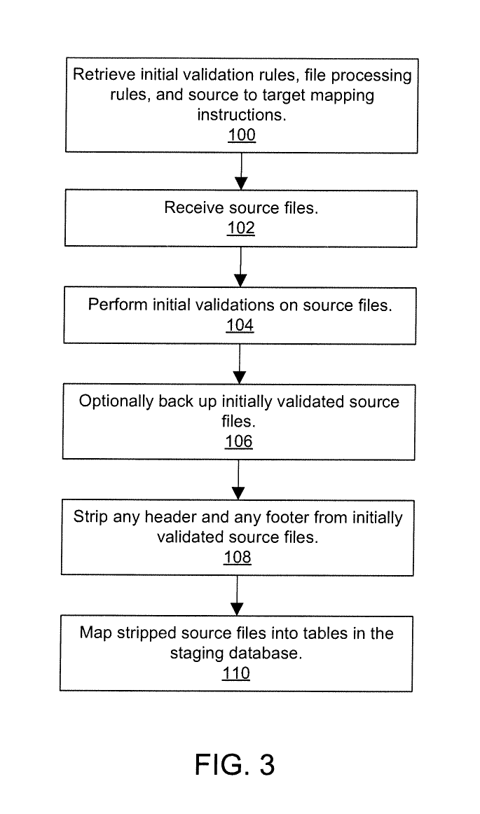

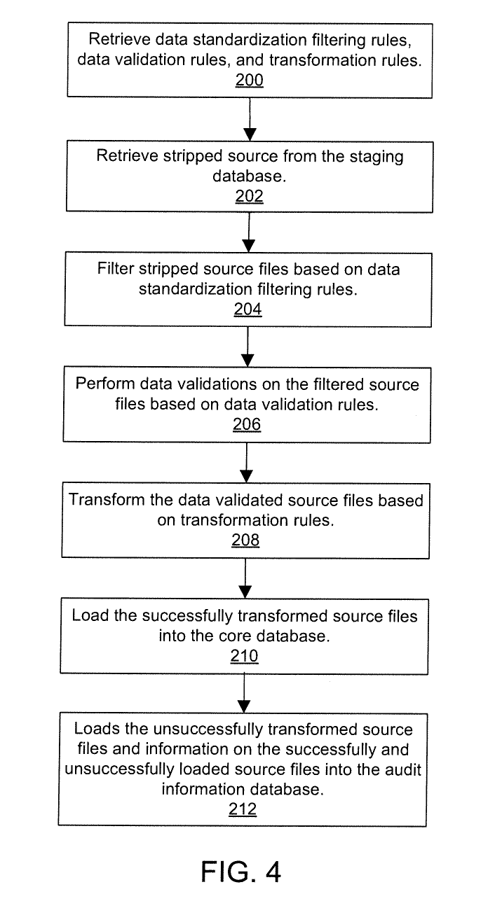

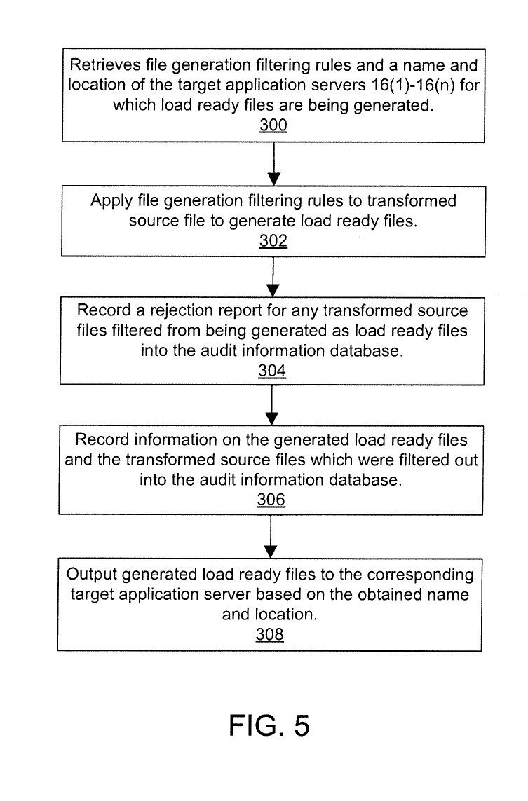

The memory 24 stores these programmed instructions for one or more aspects of the present technology as described and illustrated by way of the examples herein, although some or all of the programmed instructions could be stored and executed elsewhere. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to the processor 22, can be used for the memory 24. The memory 24 also includes a source file management engine 28, a data standardization engine 30, a data publication engine 32, a configuration database 34, a staging database 36, a core database 38, and an audit information database 40, although the memory 24 can include other types of engines, modules, databases, programmed instructions and other data. The source file management engine 28 includes a file process engine that unloads, transforms, and validates source files; the data standardization engine 30 includes standard data quality (DQ) routines, standard extract, transform and load (ETL) routines, data cleaning instructions, and data transformation instructions; the data publication engine 32 includes programmed instructions for data publication ETL routines; the configuration database 34 includes programmed instructions for source/target specifications, source/target dictionary tables, and rules threshold tables, although each of these engines and databases can have other types and amounts of routines, instructions, modules, and other data. An example of the modules and other programmed instructions executed by the source file management engine 28 are illustrated and described with reference to FIGS. 1-3, by the data standardization engine 30 with reference to FIGS. 1-2 and 4, by the data publication engine 32 with reference to FIGS. 1-2 and 5.

Referring back to FIGS. 1-2, the interface device 26 in the data intake management computing device 12 is used to operatively couple and communicate between the data intake management computing device 12 and the file source computing devices 14(1)-14(n), target application servers 16(1)-16(n), and operations console computing device 18, via one or more of the communications networks 20(1)-20(3), although other types and numbers of communication networks or systems with other types and numbers of connections and configurations can be used. By way of example, the communications network could use TCP/IP over Ethernet and industry-standard protocols, including NFS, CIFS, SOAP, XML, LDAP, and SNMP, although other types and numbers of communication networks, such as a direct connection, a local area network, a wide area network, a personal area network, such as Bluetooth, modems and phone lines, e-mail, and wireless communication technology, each having their own communications protocols, can be used.

The file source computing devices 14(1)-14(n), the target application servers 16(1)-16(n) and the operations console computing device 18 each include a central processing unit (CPU) or processor, a memory, a user input device, a display, and an interface or I/O system, which are coupled together by a bus or other link, although each of the target application servers and proxy server could comprise other types and numbers of devices, elements, and components in other configurations with other functions. In this example as illustrated and described in greater detail herein, the file source computing devices 14(1)-14(n) provide the source files, such as completed insurance claim forms by way of example, and other data for the data intake management computing device 12, although other types and numbers of computing devices with other functions can be used. Additionally, in this example as illustrated and described in greater detail herein, the target application servers 16(1)-16(n) are executing particular applications which require source data in a custom file format, such as a claim processing form with particular input fields by way of example, although other types and numbers of computing devices with other functions can be used. Further, in this example as illustrated and described in greater detail herein, the operations console computing device 18 can provide instructions, rules, and filters on data rule management and threshold management, source file specification configuration, target file specification configuration, and source to target mapping to the data intake management computing device 12 as well as provide notifications to the file source computing devices 14(1)-14(n) relating to data intake, monitor intake of data by the data intake management computing device 12, provides reports, and manage and review audit information, although other types and numbers of computing devices with other functions can be used.

Although examples of the data intake management computing device 12, the file source computing devices 14(1)-14(n), target application servers 16(1)-16(n), and operations console computing device 18 coupled together via one or more communication networks 20(1)-20(3) are illustrated and described herein, each of these systems can be implemented on any suitable computer system or computing device. It is to be understood that the devices and systems of the examples described herein are for exemplary purposes, as many variations of the specific hardware and software used to implement the examples are possible, as will be appreciated by those skilled in the relevant art(s).

Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those ordinary skill in the art.

In addition, two or more computing systems or devices can be substituted for any one of the systems in any embodiment of the examples. Accordingly, principles and advantages of distributed processing, such as redundancy and replication also can be implemented, as desired, to increase the robustness and performance of the devices and systems of the examples. The examples may also be implemented on computer device or devices that extend across any suitable network using any suitable interface mechanisms and communications technologies, including by way of example telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, and combinations thereof.

The examples may also be embodied as a non-transitory computer readable medium having instructions stored thereon for one or more aspects of the present technology as described and illustrated by way of the examples herein, as described herein, which when executed by a processor, cause the processor to carry out the steps necessary to implement the methods of the examples, as described and illustrated herein.

An exemplary automated method for managing data intake will now described with reference to FIGS. 1-5. Referring more specifically to FIGS. 1-3, an exemplary execution of the source file management engine 28 by the data intake management computing device 12 is now be described.

In step 100 the data intake management computing device 12 retrieves one or more initial validation rules, one or more of the file processing rules, and one or more source to target mapping instructions from the configuration database 34 for the source files which are coming in for one or more executing applications on the target application servers 16(1)-16(n), although other types and numbers of rules, instructions and other data can be retrieved in other manners. The operations console computing device 18 can be used to enter and/or update these rules, instructions and/or other data stored in the configuration database 34, although the rules, instructions, and/or other data could be stored in other locations. Accordingly, with this technology these instructions, rules, and filters for the initial intake of source files are easily obtained and entered by the operations console computing device 18 into the data intake management computing device 12 at the front end for automated, effective, and efficient execution of this exemplary data intake process.

In step 102, the data intake management computing device 12 receives the source files, illustrated as custom file formats in the example in FIG. 2, from one or more of the file source computing devices 14(1)-14(n), although other types and numbers of files or other data can be obtained and these files or other data can be obtained from other sources in other manners.

In step 104, the data intake management computing device 12 performs one or more initial validations on each of the source files based on one or more of the obtained initial validation rules, although other types of initial intake processing could be performed. By way of example, the initial validations may comprise determining whether any of the incoming source files is a zero byte file, contains duplicate data with another incoming source file, is an incorrect source file for the requesting application executing at the requesting target application server 16(1)-16(n), a running total check, a summary calculated values check, checksum check, and a CRC check, although other types and numbers of validations and other operations could be performed by data intake management computing device 12. The data intake management computing device 12 also may automatically store information on which incoming source files were successfully validated and which incoming source files were not successfully validated in the audit information database 40, although other types of information can be stored and in other manners and locations.

In step 106, the data intake management computing device 12 may optionally back up each of the initially validated source files in the audit information database 40, although the initially validated source files could be backed up in other manners and locations.

In step 108, the data intake management computing device 12 strips any header and any footer from each of the initially validated source files based on one or more of the file processing rules, although other types and numbers of source file processing could be executed on the initially validated source files. By way of example only, in this step the data intake management computing device 12 may also bifurcate or split initially validated source files to support one or more downstream requirements.

In step 110, the data intake management computing device 12 maps the stripped source files into tables associated with the corresponding application being executed at the one of the target application servers 16(1)-16(n) in the staging database 36 based on the obtained source to target mapping instructions, although other manners for mapping the source files can be used. The data intake management computing device 12 also may automatically store information on how the stripped source files were mapped in the audit information database 40, although other types of information can be stored and in other manners and locations

Referring more specifically to FIGS. 1-2 and 4, an exemplary execution of the data standardization engine 28 by the data intake management computing device 12 is now be described. In step 200, the data intake management computing device 12 automatically retrieves data standardization filtering rules, data validation rules, and transformation rules from the configuration database 34 for the source files which are coming in for one or more executing applications on the target application servers 16(1)-16(n), although other types and numbers of rules, instructions and other data can be obtained in other manners. The operations console computing device 18 can be used to enter and/or update these rules, instructions and/or other data stored in the configuration database 34, although these rules, instructions, and/or other data could be stored in other locations. Accordingly, with this technology these instructions, rules, and filters for data standardization are easily obtained and entered by the operations console computing device 18 into the data intake management computing device 12 at the front end for automated, effective, and efficient execution of this exemplary data intake process.

In step 202, the data intake management computing device 12 retrieves stripped source files in the tables from the staging database 36, although other types and numbers of files or other data can be obtained and these files or other data can be obtained from other sources in other manners.

In step 204, the data intake management computing device 12 filters the stripped source files in the tables in the staging database 36 based on the obtained data standardization filtering rules, although other types of file processing could be performed. By way of example, the data standardization filtering rules executed by the data intake management computing device 12 may filter out stripped source files with incomplete fields or with information in fields identified as being incorrectly entered, although a variety of different types of application specific filters could be utilized. By way of another example, the data standardization filtering rules executed by the data intake management computing device 12 may filter based on a pattern of incoming data from the source files that are not currently meeting downstream or enterprise standard requirements or may filter to execute any inclusion and exclusion conditions based on stored business rules.

In step 206, the data intake management computing device 12 performs data validations on each of the filtered source files based on the obtained data validation rules. By way of example, the data validation rules executed by the data intake management computing device 12 may verify information in filtered source files, may correct information in filtered source files and may enter missing information to complete filtered source files, although a variety of different types of data validations could be utilized. By way of example, other data validations which could be utilizes includes any data type validation, mandatory validation, format validation, range validation, numeric computation validation, special character validation, list of value validation, and any conditional mandatory validation.

In step 208, the data intake management computing device 12; transforms each of the data validated source files based on the obtained transformation rules into custom target file format obtained from the configuration database. By way of example, the transformation rules may adjust the types and numbers of fields and other formatting of the data validated source files, although a variety of different types of transformation could be performed. By way of example, other transformation which could be implemented include transforming a source data value into a standard target data value based on the condition specified in the configuration database and concatenation or bifurcation of source data value based on the transforming rule mentioned in the configuration database.

In step 210, the data intake management computing device 12 loads each of the successfully transformed source files into the core database 38 as ready for data publication, although the successfully transformed source files could be stored in other locations and in other manners.

In step 212, the data intake management computing device 12 loads each of the unsuccessfully transformed source files and records information on the successfully and unsuccessfully loaded source files into the audit information database 40, although these files and information could be stored in other locations and in other manners. In this example, the information on the unsuccessfully loaded source files loaded into the audit information database 40 includes a failure reason associated with every data rules configured for the source file unsuccessfully loaded as well as a severity rating for the reason, although other types and amounts of information could be recorded. The reason can also be configured at an attributed level.

Referring more specifically to FIGS. 1-2 and 5, an exemplary execution of the data publication engine 28 by the data intake management computing device 12 is now be described.

In step 300, the data intake management computing device 12 retrieves file definition rules and a name and location of the one of the target application servers 16(1)-16(n) for which the load ready files are being generated from the configuration database 34 for the source files which are coming in for one or more executing applications on the target application servers 16(1)-16(n), although other types and numbers of rules, instructions and other data can be obtained other manners. By way of example only, the file definition rules may be source file destination rules, target file destination rules, or a combination of both. The operations console computing device 18 can be used to enter and/or update these rules, instructions and/or other data stored in the configuration database 34, although these rules, instructions, and/or other data could be stored in other locations. Accordingly, with this technology these instructions, rules, and filters for data publication are easily obtained and entered by the operations console computing device 18 into the data intake management computing device 12 at the front end for automated, effective, and efficient execution of this exemplary data intake process

In step 302, the data intake management computing device 12 applies file generation filtering rules to the transformed source files to generate one or more load ready files, although types of rules and instructions could be used as well as other manners for generating load ready files.

In step 304, the data intake management computing device 12 record a rejection report for any of the transformed source files which were filtered from being generated as load ready files in the audit information database, although other types and other numbers of reports can be generated and stored in other locations and manners.

In step 306, the data intake management computing device 12 records information on the generated load ready files and the transformed source files which were filtered out into the audit information database 40, although other types and other numbers of reports can be generated and stored in other locations and manners.

In step 308, the data intake management computing device 12 outputs the generated load ready files to the corresponding one of the target application servers 16(1)-16(n) based on the obtained name and location, although other manners for outputting can be used as well as storing or otherwise utilizing the generated load ready files.

Accordingly, as illustrated and described with the examples herein, this technology provides methods, non-transitory computer readable medium and devices that more efficiently and effectively manage the intake of any kind of source data. As illustrated by the examples herein, this technology provides a single data intake mechanism for an entire organization eliminating the need of having to build and maintain separate intake jobs for every incoming source file. Additionally, this technology provides a single storage location for all file processing details and other audit information. Further, this technology provides a single storage location for all audit related information.

Having thus described the basic concept of the invention, it will be rather apparent to those skilled in the art that the foregoing detailed disclosure is intended to be presented by way of example, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for managing data intake, the method comprising:
defining, by a data intake management computing device, one or more of initial validation rules, one or more source to target mapping instructions, one or more data filtering rules, one or more data validation rules, one or more data transformation rules, and one or more file definition rules;
performing, by the data intake management computing device, one or more initial validations on one or more source files based on the one or more of initial validation rules;
mapping, by the data intake management computing device, the initially validated source files into a staging database based on the one or more source to target mapping instructions;
applying, by the data intake management computing device, the one or more data filtering rules to the mapped source files in the staging database;
performing, by the data intake management computing device, validation and transformation on each of the successfully filtered source files based on the one or more data validation rules and the one or more data transformation rules;
loading, by the data intake management computing device, each of the successfully validated and transformed source files into a core database;
generating, by the data intake management computing device, one or more load ready files from the validated, transformed and loaded source files based on the one or more file definition rules; and
providing, by the data intake management computing device, the generated load ready files to a requesting target computing device.

2. The method of claim 1 further comprising obtaining, by the data intake management computing device, the one or more source files from a plurality of file source computing devices.

3. The method of claim 1 wherein the performing, by the data intake management computing device, the one or more initial validations further comprises performing at least one of invalidating any zero byte source files, any duplicate source files, and any incorrect source files.

4. The method of claim 1 further comprising stripping, by the data intake management computing device, any header and any footer from each of the initially validated source files based on one or more of the file processing rules before the mapping.

5. The method of claim 1 further comprising backing up, by the data intake management computing device, each of the initially validated source files.

6. The method of claim 1 further comprising updating, by the data intake management computing device, an audit information database with information on the successfully loaded source files.

7. The method of claim 1 further comprising recording, by the data intake management computing device, each of the source files filtered from the validation and transformation based on the one or more data validation rules and the one or more data transformation rules in an audit information database.

8. The method of claim 7 further comprising loading, by the data intake management computing device, each of the unsuccessfully validated and transformed source files into the audit information database.

9. The method of claim 8 wherein the loading each of the unsuccessfully validated and transformed source files further comprises recording, by the data intake management computing device, a rejection reason and severity for each of the unsuccessfully validated and transformed source files into the audit information database.

10. The method of claim 1 further comprising updating, by the data intake management computing device, an audit information database with information on the generated load ready files.

11. A non-transitory computer readable medium having stored thereon instructions for managing data intake comprising machine executable code which when executed by at least one processor, causes the processor to perform steps comprising:
defining one or more of initial validation rules, one or more source to target mapping instructions, one or more data filtering rules one or more data validation rules, one or more data transformation rules, and one or more file definition rules;
performing one or more initial validations on one or more source files based on the one or more of initial validation rules;
mapping the initially validated source files into a staging database based on the one or more source to target mapping instructions;
applying the one or more data filtering rules to the mapped source files in the staging database;
performing validation and transformation on each of the successfully filtered source files based on the one or more data validation rules and the one or more data transformation rules;
loading each of the successfully validated and transformed source files into a core database;
generating one or more load ready files from the validated, transformed and loaded source files based on the one or more file definition rules; and
providing the generated load ready files to a requesting target computing device.

12. The medium of claim 11 further comprising obtaining the one or more source files from a plurality of file source computing devices.

13. The medium of claim 11 wherein the performing the one or more initial validations further comprises performing at least one of invalidating any zero byte source files, any duplicate source files, and any incorrect source files.

14. The medium of claim 11 further comprising stripping any header and any footer from each of the initially validated source files based on one or more of the file processing rules before the mapping.

15. The medium of claim 11 further comprising backing up each of the initially validated source files.

16. The medium of claim 11 further comprising updating an audit information database with information on the successfully loaded source files.

17. The medium of claim 11 further comprising recording each of the source files filtered from the validation and transformation based on the one or more data validation rules and the one or more data transformation rules in an audit information database.

18. The medium of claim 17 further comprising loading each of the unsuccessfully validated and transformed source files into the audit information database.

19. The medium of claim 18 wherein the loading each of the unsuccessfully validated and transformed source files further comprises recording a rejection reason and severity for each of the unsuccessfully validated and transformed source files into the audit information database.

20. The medium of claim 11 further comprising updating an audit information database with information on the generated load ready files.

21. A data intake management computing apparatus comprising:
one or more processors;
a memory coupled to the one or more processors which are configured to execute programmed instructions stored in the memory comprising:
defining one or more of initial validation rules, one or more source to target mapping instructions, one or more data filtering rules one or more data validation rules, one or more data transformation rules, and one or more file definition rules;
performing one or more initial validations on one or more source files based on the one or more of initial validation rules;
mapping the initially validated source files into a staging database based on the one or more source to target mapping instructions;
applying the one or more data filtering rules to the mapped source files in the staging database;
performing validation and transformation on each of the successfully filtered source files based on the one or more data validation rules and the one or more data transformation rules;
loading each of the successfully validated and transformed source files into a core database;
generating one or more load ready files from the validated, transformed and loaded source files based on the one or more file definition rules; and
providing the generated load ready files to a requesting target computing device.

22. The apparatus of claim 21 wherein the one or more processors is further configured to execute programmed instructions stored in the memory further comprising obtaining the one or more source files from a plurality of file source computing devices.

23. The apparatus of claim 21 wherein the one or more processors is further configured to execute programmed instructions stored in the memory for the performing the one or more initial validations further comprises performing at least one of invalidating any zero byte source files, any duplicate source files, and any incorrect source files.

24. The apparatus of claim 21 wherein the one or more processors is further configured to execute programmed instructions stored in the memory further comprising stripping any header and any footer from each of the initially validated source files based on one or more of the file processing rules before the mapping.

25. The apparatus of claim 21 wherein the one or more processors is further configured to execute programmed instructions stored in the memory further comprising backing up each of the initially validated source files.

26. The apparatus of claim 21 wherein the one or more processors is further configured to execute programmed instructions stored in the memory further comprising updating an audit information database with information on the successfully loaded source files.

27. The apparatus of claim 21 wherein the one or more processors is further configured to execute programmed instructions stored in the memory further comprising recording each of the source files filtered from the validation and transformation based on the one or more data validation rules and the one or more data transformation rules in an audit information database.

28. The apparatus of claim 27 wherein the one or more processors is further configured to execute programmed instructions stored in the memory further comprising loading each of the unsuccessfully validated and transformed source files into the audit information database.

29. The apparatus of claim 28 wherein the one or more processors is further configured to execute programmed instructions stored in the memory for the loading each of the unsuccessfully validated and transformed source files further comprises recording a rejection reason and severity for each of the unsuccessfully validated and transformed source files into the audit information database.

30. The apparatus of claim 21 wherein the one or more processors is further configured to execute programmed instructions stored in the memory further comprising updating an audit information database with information on the generated load ready files.
